(19) United States
(12) Patent Application Publication
(10) Pub. No.: US 2015/0213737 A1
(43) Pub. Date: Jul. 30, 2015

(54) Bolt Security Seal with Reusable Electronics Module and Bolt

(71) Applicants: Robert Debrody, Wayne, NJ (US); Donald Ruth, Newton, NJ (US); George Lundberg, Pompton Plains, NJ (US); Richard Dreisbach, Lafayette, NJ (US)

(72) Inventors: Robert Debrody, Wayne, NJ (US); Donald Ruth, Newton, NJ (US); George Lundberg, Pompton Plains, NJ (US); Richard Dreisbach, Lafayette, NJ (US)

(21) Appl. No.: 14/613,528

(22) Filed: Feb. 4, 2015

Related U.S. Application Data
(63) Continuation of application No. 12/239,869, filed on Sep. 29, 2008, now abandoned.
(60) Provisional application No. 60/997,858, filed on Oct. 5, 2007.

(51) Int. Cl. G09F 3/03

(52) U.S. Cl. CPC G09F 3/0317; G09F 3/0376

(57) ABSTRACT

An electronic circuit senses and transmits a tamper condition of a bolt seal locked with a locking device external the module on a side of the module opposite the bolt head. The module is reusable intact when the bolt/locking device, which is conventional, is opened. In various embodiments, a tang type metal/plastic or plastic tamper indicative seal may be attached through a hole in the bolt tip region that has a narrowed diameter tip or attached in a one way clutch action on the tip, or which mates in a bolt groove at the bolt tip region and/or a conventional tamper evident seal is attached to the surface of the bolt shank at the bolt tip region in a clutch action. Different bolt embodiments comprise non-electrically conductive or electrically conductive plastic or steel shanks with juxtaposed electrical conductors along the shank connected to external conductors formed by coatings or axially spaced cylindrical sleeves forming contact regions which engage the circuitry contacts inside the module.

This application claims the benefit of U.S. Provisional Application Ser. No. 60/997,858 filed Oct. 5, 2007 in the name of Robert Debrody et al. and incorporated by reference herein in its entirety.

This invention relates to electronic security seals of the type including a bolt and a locking body for securing a hasp of a container or cargo area door. The seal includes electronics for sensing the locked state of the bolt and for transmitting the locked and tampered states.

OF INTEREST ARE THE FOLLOWING PATENTS

Of interest are commonly owned U.S. Pat. Nos. 5,005,883, 5,127,687, 4,802,700, 5,347,689, 5,413,393, 6,265,973 ('973), 6,407,666 ('666), 6,097,306 ('306), 7,239,238 ('238) and others for the disclosure of various seals including electronic seals ('973, '666 and '238)(a programmable seal '306) and including shackles made of stranded metal wire ('238), steel bolts ('666 and '973) and still other arrangements, all incorporated by reference herein.

Containers are widely employed in the cargo industry. The containers have doors which are locked shut with hasps and secured with locking seals. Such seals typically include a steel bolt having a head and shank which is locked in the locked state to a locking device comprising a body having a shank locking mechanism. Such a device and mechanism are shown for example in U.S. Pat. No. 4,802,700. When the shank is inserted into the body, a locking collet or other structural arrangement permanently locks the shank to the body. Further examples of such seals and locking devices are included in the above referenced U.S. patents.

Cargo containers are shipped via land, sea and air transportation. Hundreds of containers may be on a single ship. When the containers are unloaded they may be subject to tampering and vandalism. It is important that such tampering be immediately noted to preclude theft of valuable cargo. To assist in such theft and tampering prevention, prior art seals are assigned serial numbers. These seals are then assigned and locked to the assigned container. The serial number, container number, the carrier, and the location of the cargo are entered into a local computer. The entry then is manually made to show that the container is being shipped out of that location. Should a seal be tampered with, the event may be discovered at a different time and different location.

An electronic tagging device is commercially available that is programmable and which transmits information that is programmed, such as tagging identification serial numbers and other information as desired. This is referred to as radio frequency identification (RFID) which is well known in the art. Generally, an RFID tag will have a radio frequency (RF) transmitter, an RF receiver, an RF modulator, and a memory. The memory retains the digital code manifesting the identification number. The RF modulator extracts the digital code representing the identification number as a modulated signal which is applied to the RF transmitter. The RF receiver receives interrogation and control signals which manifest a request for the identification number.

Such systems provide security tagging for high value merchandise as it is transferred from the manufacturer to the consumer. Other applications include tagging of animals, humans and vehicles such as trucks and their cargo containers. Other applications include automatic toll collection systems.

FIG. 33 illustrates a prior art RFID communication system 214. The system includes an interrogator 216 and an RFID tag 218. The interrogator 216 includes a host controller 220 to process received information from the RFID tag 218 via antenna 222 and receiver 224. To retrieve information from the RFID tag 218, the host controller 220 generates an interrogation command signal which is transmitted by transmitter 226 and antenna 228 as signal 230. The tag 218 transmits RFID signal 232 via antenna 234 in response to receipt of the interrogation command signal 230. The receiver 224 receives the signal 232 via antenna 222. The signal 232 manifests the identification number of the tag 218.

The RFID tag 218 has an antenna 236 and a receiver 238 to receive the interrogation command signal 230 from the interrogator 216. The receiver 238 transfers the received command signal to a controller 240. The controller 240 interprets the command and extracts the corresponding identification number (ID) from memory 242. The extracted identification number is then transferred by the controller 240 to transmitter 244 which transmits the ID to antenna 234 which broadcasts the signal 232.

In active RFID tags, power 246 is provided by a battery system. In passive systems, the power is induced from the received signal. The signal 232 transmitted by the RFID tag 218 is modulated back scatter of the original signal transmitted by the interrogator 216.

The controller 240 may have an interface, not shown, to receive data from external transponders such as temperature sensors, pressure sensors, global positioning sensing and other telemetric measurement data.

Commonly owned U.S. Pat. No. 6,265,973 discloses an electronic security seal which is used with a steel bolt having an insulating coating thereon and a metallic coating on the insulating coating. The metallic coating is in ohmic contact with the bolt head to form a continuous conductor with the bolt shank. A pair of electrical contacts engage the shank and metallic coating to form a circuit path between the contacts. The contacts are coupled to the circuit for sensing a break in the path manifesting a tampered condition wherein the bolt may have been severed opening the path.

U.S. Pat. No. 7,239,238 discloses an electronic security seal using a stranded cable shackle having an internal conductor whose resistance manifests the tampered state of the device and which resistance is monitored by the circuit. This exhibits a similar problem as the '973 patent discussed above. When the shackle is destroyed to open the seal, the entire assembly needs to be discarded. This too is costly.

U.S. Pat. No. 6,407,666 discloses an electrical connector for a cylindrical member such as a steel bolt. Disclosed are a pair of spaced apart rings or similar shaped contacts that make contact with the bolt for completing the circuit between the bolt and sensing circuit. The circuit is for generating a signal manifesting a tampered state of the bolt when the bolt is severed breaking the circuit. The bolt in this device if severed to open the seal results also in the entire assembly being discarded, a costly system.

U.S. Pat. No. 7,042,354 (which includes a family of patents U.S. Pats. Nos. 6,778,083, 6,791,465, and US publications 2006/0170560 and 2006/0109111) discloses a tamper resistant electronic security seal. The seal comprises a bolt shank, a head which houses the seal circuitry and a bolt locking device which mates with a groove in the bolt shank similar to prior art locking devices. Such a device is shown for example in U.S. Pats. Nos. 4,802,700 and 5,005,883. To open the seal sealed with such a bolt, the bolt needs to be severed and the entire assembly is discarded as the locking device is permanently attached to the bolt via a groove in the bolt. This presents the same problem of cost in using this seal as the seals described above.

U.S. Pat. No. 6,747,558 ('558) describes an electronic bolt type security seal using two adjacent magnetic fields as bolt sensors. The fields are generated by two corresponding coils located in corresponding two adjacent arms extending from an electronic seal module housing the rest of the circuitry. The bolt passes through the arms and coils. A locking device is attached to the bolt to secure the bolt to a hasp. When the bolt is severed, the seal module and arms may be reused. However, this design is different than the commercially available modules of the prior art seals discussed above, which seals require that the electronic modules be discarded when the bolts are opened and also discarded. This patent does not solve the problem with those other prior art electronic bolt seals because it uses a different circuitry than the prior art circuitry commonly used. The present inventors recognize a need for use of an electronic module that employs prior art circuitry and that is housed entirely in the module housing and is also reusable, a problem not addressed by U.S. Pat. No. 6,747,558, since the relatively small coil portion of the circuitry (not used in conventional seal tamper evident circuits) is housed in arms separate from the electronics circuitry housing for the majority of the involved circuits etc.

The patent '558 also describes seals with reusable housings and disposable bolts. These seals are not described as being electronic however. In this description, an end of the bolt is locked inside the seal housing not otherwise described. To open the seal the bolt is cut with a bolt cutter. The end of the bolt inside the housing can then be removed by sliding the remaining bolt portion out of the housing in the same direction as the insertion direction. This seems to require the housing to be opened to access the bolt fragment to remove it from the housing. No drawing or reference document is cited by the '558 patent showing the particular device being described therein. While this device may solve the problem of providing a reusable housing, it does not seem to be directed to electronic seals.

In the '973 patent, the housing appears to be needed to be opened to remove the remnant of the cut bolt from inside the housing. In electronic seals, opening the housing is not desirable as the electronic circuitry inside the housing may become contaminated and unusable. The present inventors have recognized a need for an electronic seal module that is both reusable and which need not be opened to reuse the module and thus avoid contaminating the interior circuit. A need is also recognized for a reusable electronic seal module for use with conventional tamper evident circuits and conventional bolt locking devices and indicative security seals which are not as robust as a bolt seal and are provided mainly to show tamper evidence.

The latter seals are of the strap, padlock and similar arrangements typically made of thermoplastic and are low cost. They are used to indicate tampering with various hasps such as used on electric or gas meters, mini bars as used in hotels and airlines, and a host of other applications where tamper evidence is desired rather than a robust secure locking device as provided by bolt seals in particular.

U.S. Pat. No. 5,152,650 discloses an electrically conductive synthetic resin bolt.

German document DE 010322648 discloses plastic fixing screws for door lock cylinders with embedded conductive strips to operate an alarm if the bolt is deformed by tampering.

Int'l application WO 2006/074518 discloses a transponder bolt seal and a housing for a transponder. An actuator is actuated upon engagement of the sealing mechanism to render the transponder operable. Insertion of a locking member into a receptacle causes the actuator to actuate. The device has a curved shape with a convex side facing away from the sealing mechanism and a concave side facing the sealing mechanism. A cover is used and if the bolt is removed, the cover is damaged, and thus this seal is not reusable if the bolt is removed to open the seal. This application does not address the need for a less costly seal system employing a reusable electronic seal module for use with conventional bolts and locking devices.

An electronic security bolt seal with a reusable electronics module according to an embodiment of the present invention comprises an electronics module comprising a housing having a cavity and a electronic circuit in the cavity for sensing and transmitting the tamper state of the seal. A bolt is included having a head and an elongated shank engaged with the housing cavity and circuit, the bolt for completing the engaged circuit and for engaging a hasp to be secured. The seal also includes a bolt locking device engaged with and locked to the bolt external the module to secure the module to the bolt in the locked state, the circuit for sensing the integrity of the engaged locked bolt manifesting the seal tamper state, the locked bolt having an exposed region external the module for selective opening to open the seal and release the module from the bolt for reuse of the module and to release the bolt from a hasp.

Consequently, the module need not be opened to remove the bolt contrary to that disclosed in U.S. Pat. No. 6,265,973 and also preferably employs a conventional prior art tamper indicating circuit.

In another embodiment, the bolt is dimensioned to pass through the housing and includes a tip portion protruding from the housing, the tip portion and the locking device being arranged to lock the locking device to the tip portion.

In a further embodiment, the shank is dimensioned to pass through the housing and includes an end portion protruding from the housing, the end portion having a recess in the surface thereof, the locking device includes a locking element for engaging the recess to lock the locking device to the groove.

In a further embodiment, the bolt has a tip distal the head and protrudes from the module, the tip having an aperture for receiving a security seal shackle therethrough.

In a further embodiment, the bolt has a tip distal the head and protrudes from the module, the tip having a groove therein for engaging with and locking to the locking device.

In a further embodiment, the bolt has a tip distal the head, the bolt having one of a hole and groove therein in a region intermediate the tip and engaged module.

In a further embodiment, the bolt comprises an electrical insulator, the bolt including first and second electrically conductive members attached to the shank in spaced electrical isolation from each other distal the head, and an electrical conductor ohmically connected to the conductive members and extending along the shank from the head to the members to form a circuit path to and between the members.

In a further embodiment, an electronic security seal comprises a head and a shank extending from the head to a tip portion distal the head. Electrical conductors are coupled to the head and shank for completing an electrical path to an electronic tamper evident transmission circuit. A tamper indicative seal is attached to the tip portion.

In a further embodiment, the shank is an electrical insulator.

In a further embodiment, the shank is an electrical insulator and the tip portion has a diametrical dimension smaller than the shank for receiving a one way clutch acting locking tamper indicative seal which locks to the tip portion in the one way clutch action.

In a further embodiment, the bolt tip portion has a hole therethrough and the tamper indicative seal has a shackle portion passing through the hole.

A bolt for use with an electronic security seal module having an aperture in its housing for receiving the bolt in an internal housing compartment according to a further embodiment wherein the received bolt is for engagement with tamper evident sensing circuitry in the compartment, the bolt comprising a head and a shank extending from the head to a tip portion distal the head, the shank being dimensioned to be inserted through the aperture into the compartment.

Electrical conductors coupled to the head and shank for completing an electrical path to the circuitry along the shank and in the head and a sealing arrangement is attached to and encircles the shank for engagement with the module housing at the aperture for sealing the interface of the sealing arrangement with the module housing at the aperture.

In a further embodiment, the shank has an outer peripheral surface, the sealing arrangement comprising a sealant material on the outer peripheral surface of the bolt.

In a further embodiment, the sealant material on the outer peripheral surface of the bolt tapers to a relatively narrow diameter in a direction from the bolt head to the tip portion.

In a further embodiment, the sealing arrangement comprises an electrically insulating coating.

In a further embodiment, the insulating coating extends about the shank and head from a region medially the bolt shank to and over the head.

In a further embodiment, the tapering region of the sealing arrangement is for sealing engagement with the module at the aperture.

### IN THE DRAWING

FIG. 1 is a front elevation view, partially in section, of an electronic security seal attached to a hasp according to an embodiment of the present invention;

FIG. 1a is an isometric view of the locking device of FIG. 1;

FIGS. 2 and 3 are respective exploded isometric views of a portion of the electronic seal module of FIG. 1, FIG. 2 showing the view from the bottom of the seal module and FIG. 3 showing the view from the top of the seal module;

FIG. 4 is an isometric view of a representative electrically conductive pin that is staked to the housing of the module of FIGS. 2 and 3 for electrically connecting electrical contacts engaging a bolt with the printed circuit bolt sensing and transponder circuitry;

FIG. 5 is an elevation sectional view of the electronic module of FIG. 7 taken along lines 5-5;

FIG. 5a is an elevation sectional view of the module housing similar to FIG. 5 but without the interior components of FIG. 5;

FIG. 6 is an elevation sectional view of the electronic module of FIG. 7 taken along lines 6-6;

FIG. 7 is top plan view of the electronic module of FIG. 1;

FIG. 8 is a plan sectional view of the electronic module of FIG. 7 taken along lines 8-8 of FIG. 5, in FIG. 8, the lines 5-5, 6-6 and 9-9 are given for illustration to show where in the structure the views at lines 5-5, 6-6, and 9-9 in FIG. 7 are taken;

FIG. 9 is an elevation sectional view of the electronic module of FIG. 7 taken along lines 9-9;

FIG. 10 is an elevation sectional view of the bottom cover of the electronic module of FIG. 3 taken along lines 10-10;

FIGS. 11a, 11b and 11c are respective isometric, side elevation and front elevation views of the electrical contacts employed in the embodiment of FIGS. 2 and 3;

FIG. 12 is an isometric partially in section view of a schematic representation of a bolt, an attached bolt locking device and electronic module according to an embodiment of the present invention;

FIG. 13 is an elevation partially in section view of the bolt assembly of FIG. 12 showing the module housing, bolt locking device and bolt electronic module and showing the electrical conductors in the bolt;

FIG. 14 is a sectional side elevation view of a bolt locking device employed in the disclosed embodiments;

FIG. 15 is a side elevation partially in section of a schematic representation of a bolt according to the embodiments of FIGS. 12 and 13 without the locking device attached;

FIG. 16 is a side perspective view of a further embodiment of a bolt, seal and contact arrangement of an electronic seal with a key padlock attached to the bolt according to the embodiment of FIG. 17;

FIG. 17 is a side elevation view of a bolt for the embodiment of FIG. 16;

FIG. 18 is a side perspective view of a further embodiment of a bolt, seal and contact arrangement of an electronic seal with a tamper indicative seal attached to the bolt via a hole in the bolt tip with the indicative seal shackle passing through the hole according to a further embodiment of the bolt;

FIG. 19 is a side perspective sectional view of a bolt, seal and contact arrangement of an electronic seal with a tamper indicative seal attached to a narrowed bolt tip, the indicative seal having a metal tang locking device with an aperture that acts as a one way clutch that receives therethrough and locks the indicative seal to the bolt tip according to a further embodiment;

FIG. 20 is a side perspective view of the electrically conductive portion of the bolt of FIG. 30;

FIG. 21 is an alternative construction of the electrically conductive portion of a bolt comprising non-electrically conductive material;

FIG. 22 is a schematic diagram of a prior art circuit of an RFID and interrogator circuit; and

FIG. 23 is a block circuit diagram of a prior art circuit which may be used with the electronic module of the seal according to an embodiment of the present invention.

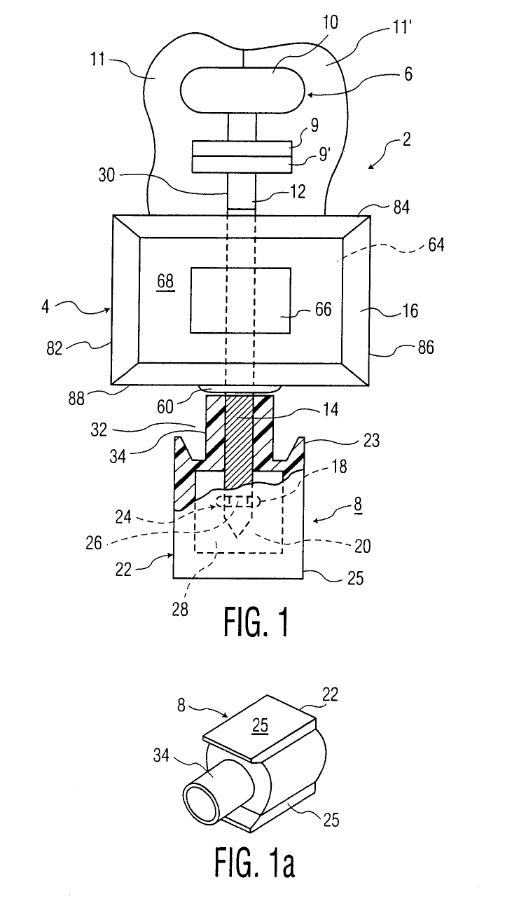

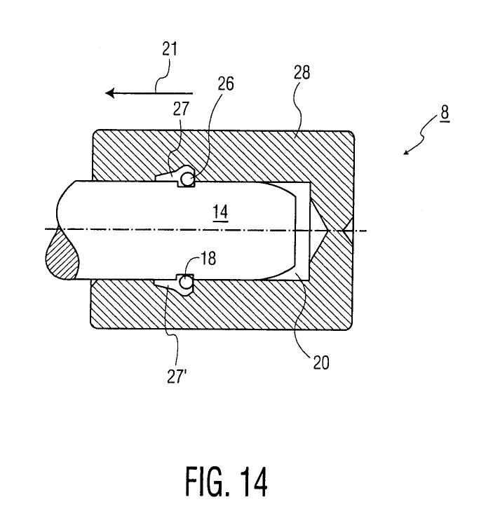

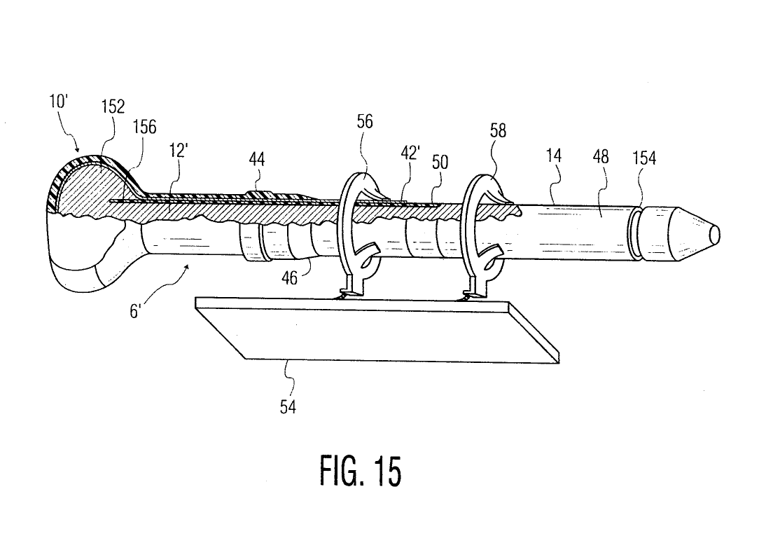

In FIG. 1, electronic bolt type security seal 2 according to one embodiment of the present invention includes an electronic seal module 4, a bolt 6 and a locking device 8 (FIG. 1a and FIG. 14, without outer shell 22 of FIG. 1). The bolt is locked to hasps 9, 9′, and to the module 4 by the locking device 8. The module 4 comprises a housing 16 having a cavity and internal components in the cavity to be described below. The bolt seal 2 locks hasps 9, 9′ together and releasably secures the module 4 to the hasps as well. The hasps 9, 9′ may be part of a cargo container door 11 and door jamb 11′, for example, for locking the container door 11 shut.

In FIGS. 1, 12 and 13, the bolt 6 has a head 10 and a shank 12, which is circular cylindrical, but may be other shapes. The shank 12 has a tip portion 14 which protrudes through the housing of the module 4. The bolt has a tip portion 14 that protrudes from the module 4 and is locked to the locking device 8 via an annular groove 18 in the outer circumferential surface of the bolt tip portion 14.

In FIG. 14, the locking device 8 (without the shell 22) is shown in more detail. The locking device has a steel body 28 with a cavity 20. Inside the cavity 20, there is a locking mechanism 24 which comprises a partial spring steel ring 26. The ring 26 is received in internal annular stepped groove 27 in the locking body 28 cavity 20. The cavity 20 forms a longitudinal bore. The groove 27 has an enlarged tapered section and a smaller diameter cylindrical portion in the cavity 20. The ring 26 in the groove 27 expands in the tapered section as the bolt tip portion 14 is inserted. The ring 26 then becomes aligned with the groove 18 when the bolt shank portion 14 is inserted into the cavity 20. The ring expands in response to the shank insertion into the cavity 20 and then returns to its quiescent diameter by its compressing partially into the shank groove 18.

When the bolt 6 is attempted to be unlocked by retracting it out of the cavity 20, direction 21 opposite the insertion direction, the ring 26 is compressed further into the groove 18 of the bolt by a smaller diameter step 27′ in the body groove 27. The step 27′ in the body groove 27 and the bolt groove 18 cooperate to lock the ring and bolt to the body 22 to preclude further withdrawal of the bolt from the body bore 20. The locking mechanism 24 permanently locks the bolt 6 tip portion 14 to the body 28 requiring the bolt to be severed to open it.

The locking device 8, FIGS. 1, 1a, 12 and 13, has an outer thermoplastic molded shell 22 encasing the inner steel body 28.

The only way to open the seal 2 is to cut the bolt 6 with a bolt cutter or similar device. For this purpose, the shank 12, FIG. 1, is shown for illustration with an exposed region 30 between the module 4 and the hasps 9, 9′ and an exposed region 32 between the locking device 8 and the module 4. In practice, the only exposed regions for receiving a bolt cutter is region 32. While the region 30 and a further exposed region of the bolt is shown in FIG. 1 between the hasp and head 10, this is only for illustration.

The thermoplastic shell 22 of the locking device 8 has a thermoplastic collar 34 one piece with and extending from the shell. The bolt shank 12 region 32 is substantially covered by the collar. In practice, the shank region 30 between the module 4 and the hasp and the shank region between the hasp and the head 10 is non-existent with a close clearance with the bolt at these regions. Thus a bolt cutter will not have access to the shank 14 in these other regions. In this case, the only access to cut the shank is in the region 32. The locking device collar 34 being plastic is easily severed.

The collar 34 secures the module 4 tightly against the bolt and also in a further embodiment against the hasp 9, 9′ (not shown). This action seals the module 4 interior from the external ambient atmosphere as will be explained. Also this action keeps the module from moving along the bolt shank or vibrating in use in the locked state. This action tends to minimize wear of the contacts to be described below. The shell 22 FIGS. 1, 12 and 13 has an overhang portion 23 which overlies a portion of the collar 34. The shell 22 has opposing planar side walls 25 including the overhang portion 23 for receiving indicia such as a unique bar code and/or the manufacturer name and so on.

Once the bolt is cut at the exposed region 32 (or some other region) it can readily be removed from the module 4 and the hasps 9, 9′. This is because there is no locking device internal the module 4 as in some of the prior art electronic security seals. Thus the module 4 is reusable with a new bolt. This reuse is made possible without undesirable opening of the module housing 16 as occurs in some prior art electronic seal systems discussed in the introductory portion.

The bolts 6 are relatively low cost and disposable. The module 4 being relatively costly because it houses the electronics, is saved for reuse and is readily reused after each use. This arrangement provides for users who have high volumes of needs for this type of seal.

To reuse the module 4, a new bolt is inserted through the housing 16 and locked with another relatively low cost locking device, which is also disposable. The electronics, according to a particular implementation employed as known in the prior art, may need to be reprogrammed for each new use in a known way as shown for example below and in certain of the patents noted in the introductory portion. The reprogramming may employ an interrogation unit or other programming arrangement as disclosed in some of the cited patents in the introductory portion. Such programming includes entering the seal unique identification, date and time stamps, location, cargo data, and any other desired data. For example, see several of the Patents cited in the introductory portion, which disclose such electronics in more detail such as the '238, 973, 558 and 354 patents among others, and incorporated by reference herein.

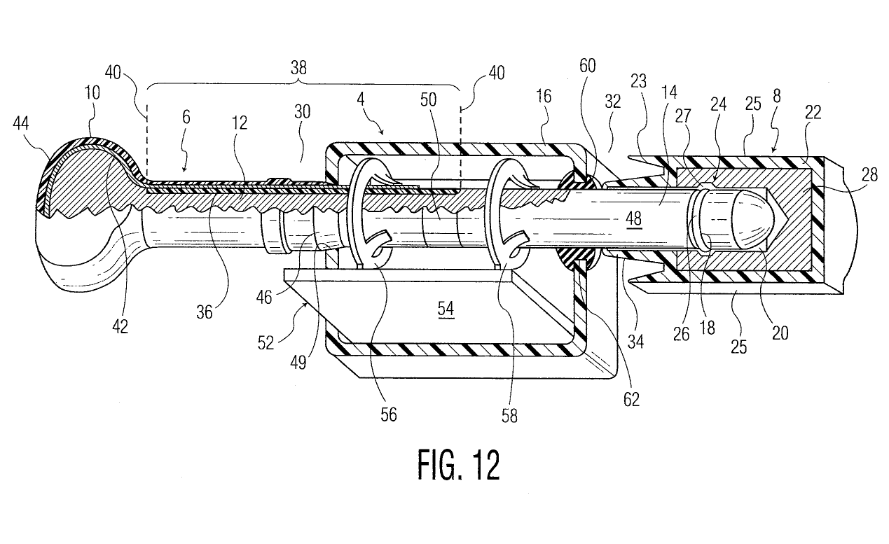

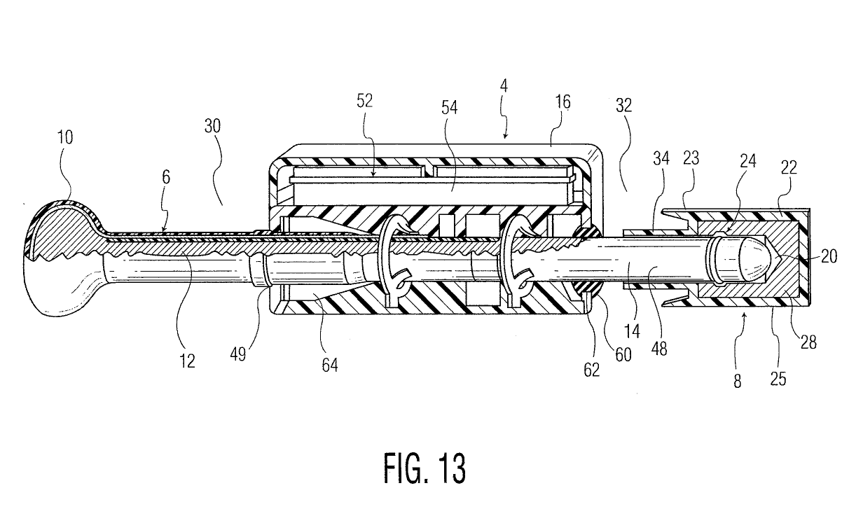

In FIGS. 12 and 13, the bolt 6, in one embodiment, comprises a steel bolt shank 12 and steel head 10, which are electrically conductive. An electrically insulating coating 36, which may be plastic, a composite material, or other insulating material, is applied in a conventional manner such as by molding, dipping, vapor deposition, and so on. The coating 36 is applied over an annular shank portion 38 (bounded by dashed lines 40) of the shank 12 adjacent to the bolt head 10. The head 10 and shank 12 may also be one piece or multiple piece metal structures and together form an electrically conductive single conductor. The head for example may be press fit onto the shank in a known manner.

An electrically conductive layer 42 or coating, such as a metal or equivalent conductive material, such as a foil, or metal or carbon impregnated or loaded composition (not shown), is deposited or bonded to and over the insulation coating 36. Such material is deposited by conventional processes. The layer 42 is also deposited or attached to the head 10 in ohmically conductive contact with the metal head 10 to form a continuous electric path with the head and the coating layer 42 portion overlying the insulated portion of the shank 12. The layer 42 for example, if a metal foil, may be bonded to the bolt at the head with an electrically conductive adhesive (not shown) and any kind of adhesive to the insulating coating 36. An insulating outer layer or coating 44 such as rubber or plastic or the like is, in one embodiment, molded or otherwise formed over the conductive layer 42. The outer insulating coating 44 is over the entire region of the metal layer 42. An example of a bolt similar to the bolt 10 of FIG. 12 is also shown in the '973 patent incorporated by reference herein.

The bolt outer rubber or plastic layer 44 has a tapered conical region 46 which narrows in diameter in a direction toward the tip portion 14. The module 4 housing 16, FIGS. 12 and 13, has a cylindrical circular aperture 49 for receiving the tapered outer surface region 46 of the bolt shank 12 therein. The bolt region 46 is larger in diameter than the diameter of the aperture in the housing 16 into which the bolt is inserted. This smaller diameter of the aperture 49 as compared to the larger diameter of the region 46 in a direction toward the head 10 prevents the bolt shank 12 from passing further into the aperture beyond the region 46 between the region 46 and the head 10. Thus, only a predetermined tip portion 14 of the shank 12 can enter into and protrude beyond the module 4 cavity. This predetermined tip portion 14 of the shank 12 length protruding beyond the module 4 is determined by the position of the region 46 on the shank relative to the tip portion 14.

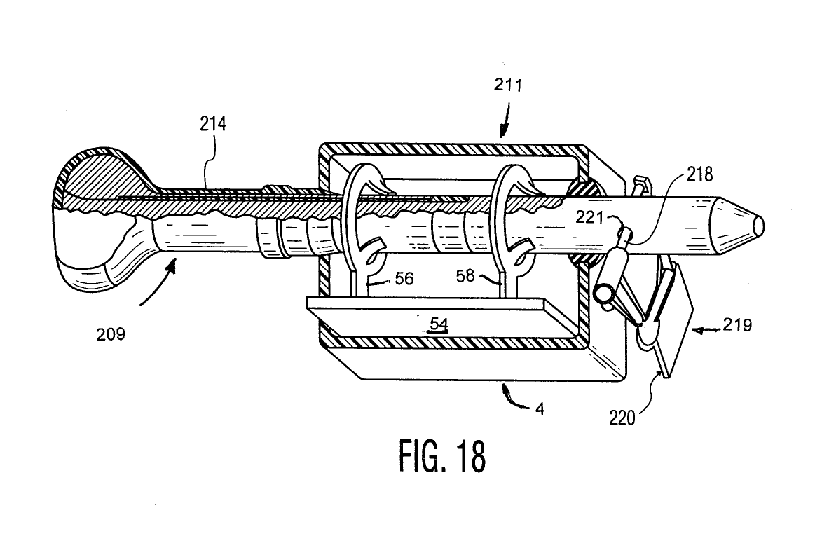

This region 46 with its varying diameter along the bolt length relative to the aperture 49 diameter positions the shank 12 tip portion 14 with its metal outer surface and the shank electrical coating 42 in a desired predetermined aligned position in the module interior. This positioning of the bolt coating 42 aligns electrical contacts 56, 58, FIGS. 12 and 13 (to be described below) of the module 4, with the respective coating 42 and metal tip portion 14. This alignment ensures the contacts 56, 58 make the required ohmic electrical engagement with the spaced electrically isolated and electrically conductive contact portions of the bolt. These portions form an electrical path along the shank 12 axial length as seen from FIGS. 12-16 and 18, wherein part of the path is provided by the electrically conductive bolt shank and the electrically conductive layer 42 juxtaposed with a portion of the shank 12.

These conductive shank conductive portions include the shank 12 which has an outer exposed metal surface electrically conductive portion 48 at the tip portion 14 and the electrically conductive layer 42 aligned with the contacts 56, 58. The insulating coating 36 has an annular region 50 at the shank outer peripheral surface. This region 50 electrically isolates the tip 14 conductive portion 48 of the shank 12 outer surface from the electrically conductive layer 42 along an axial extent of the shank 12.

Thus, when the tapered region 46 is axially displaced toward the module 4 and tightly fitted into the aperture 49 of the module housing 16, the ring contacts 56, 58 of the module 4 become aligned with the respective electrically conductive portions of the bolt 6. Also, the tapered region being formed of rubber or plastic forms a contamination seal for sealing the aperture 49 from the external ambient atmosphere. This is important to ensure the electronics does not prematurely corrode or otherwise fail due to ambient contamination. This sealing action of aperture 49 prevents moisture and other contaminants from entering into the module 4 interior of its housing 16 protecting the internal electronic components. The prior art seals do not recognize this problem or offer a solution.

In FIGS. 12 and 13, the module 4 includes a printed circuit board assembly 52 comprising a circuit board 54 mounted inside of the module housing 16. The circuit board 54 has the necessary electronic and mechanical components (not shown) of the seal tamper sensing and RFID operating circuit mounted thereto. The electrically conductive conductors and contacts (not shown) of the board 54 are formed on the board 54 in a known manner.

The circuit includes a pair of spaced apart ring contacts 56 and 58 mounted spaced from the board 54, but electrically connected thereto as will be shown below. These contacts 56, 58 are electrically conductively connected to the specified contact pads (not shown) of the board 54. FIG. 12 is more schematic than FIG. 13, which is more representative of the construction of the module 4 than FIG. 12, which is for illustration. The contacts 56, 58 are in the interior 64 of the module, FIGS. 12 and 13.

In FIGS. 12, 13, a rubber or other material sealing grommet 60 is secured in an opening 62 in a wall of the module housing 16 opposite to and aligned with the aperture 49. The opening 62 provides egress for the shank tip portion 14 into the housing 16 interior compartment 31. The grommet 60 is closely dimensioned relative to the outer diameter of the shank 12 tip portion 14 to resiliently compress somewhat and seal the shank tip portion 14 inserted into the grommet bore 61 (FIG. 12) into compartment 64 of the housing 16. This sealing action occurs when the grommet receives the shank 12 for sealing the module 4 interior. The grommet seals the compartment 64 of the module 4 from external moisture and contamination to protect the circuit within the housing 16 compartment 64 at the tip portion 14.

The grommet 60 permits the bolt shank 12 tip portion 14 to slide through the grommet opening 61 and protrude beyond the housing 16 as shown (FIGS. 1 and 12). The protrusion of the shank tip portion 14 permits the locking device 8 to be attached thereto and thus lock the module 4 to the bolt 10 (and the module 4 and bolt 10 to the hasp 9, 9′ (FIG. 1). The plastic collar 34 on the locking device 8 shell 22 (FIG. 1) has an important function. It locks and seals the housing 16 aperture 49 against the tapered plastic or rubber molded region 46 of the bolt 6 in the locked mode (FIGS. 12 and 13). This ensures that the locked module 4 housing 16 is fully seated against the region 46 while the bolt shank tip portion is sealed by the grommet 60. Thus the module 4 compartment 64 is sealed against the ambient contaminants such as moisture and the like at the same time precluding circuit damage therefrom.

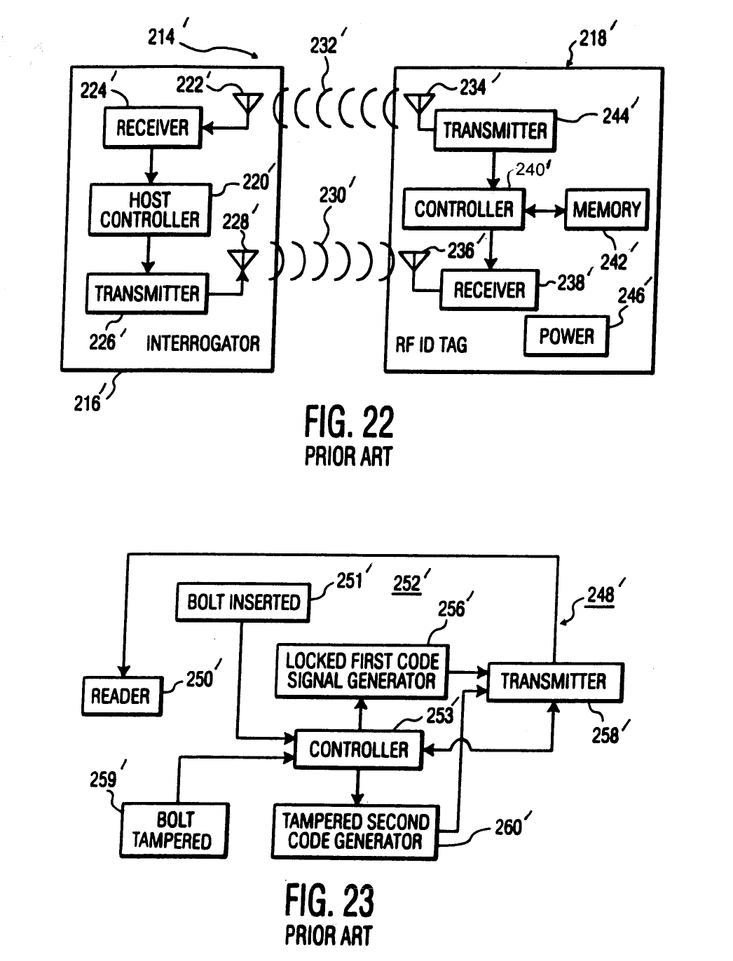

A printed circuit board assembly 52 schematically shown in FIGS. 12 and 13, comprises a circuit board 54, FIG. 13. The board 54 includes a programmable circuit (not shown) comprising a CPU, a computer processing unit, memory and other circuit components such as crystals, capacitors and resistors for providing a programmable transmitting RFID tag circuit similar to the circuit of FIG. 22, or as shown in certain of certain of the patents noted in the introductory portion incorporated by reference herein. The board 54 has ring contacts 56, 58 electrically conductively coupled thereto and to the contact pads (not shown) printed on the printed circuit board 54 via pins 98, 100 to be described. The ring contacts 56, 58 are mechanically spaced from the board 54.

The circuit (not shown in this figure) on board 54 may be programmed for receiving a seal identification code, i.e., a unique number assigned a particular seal, geographic location where the seal is being deployed, container identification, e.g., a unique number assigned to a cargo container, the shipping carrier for the container, the container port of origin, container destination, inventory of the container and other data. Such a programming circuit is within the skill of one of ordinary skill in the computer programming art.

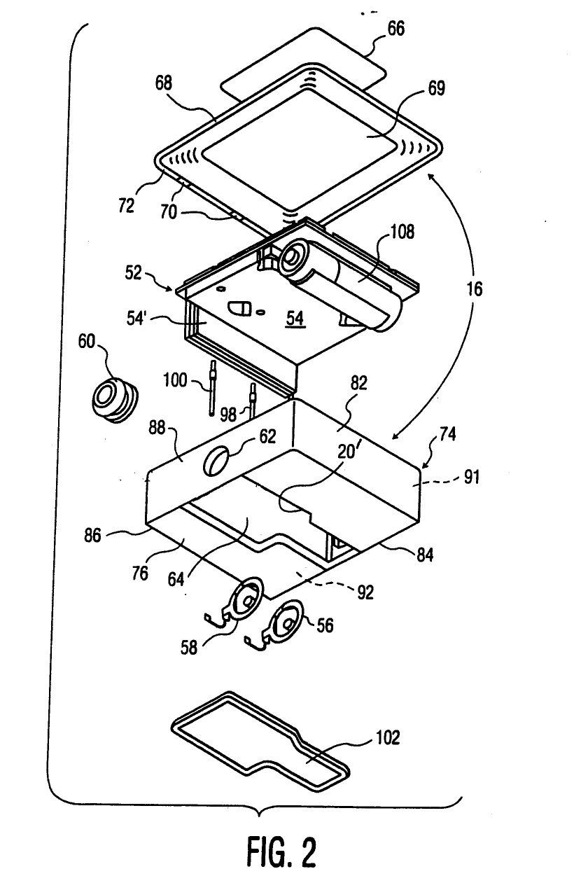

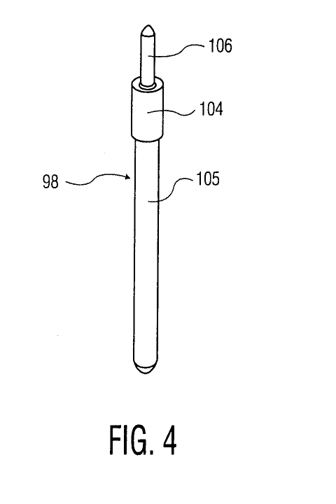

Resilient ring contacts 56, 58, FIGS. 12 and 13 e.g., may be made of beryllium copper, are coupled to the board 54 and ohmically coupled to the circuit of FIG. 23 on the board 54 by pins 98, 100 (FIG. 4 shows representative pin 98) for providing electrical battery power to the circuit by closing an ohmic connection between the circuit and battery 108, FIGS. 2, 3, 5 and 8, when the bolt 10 is inserted into the module as shown in FIGS. 12 and 13. The contacts 56, 58, provides a serial connection to opposite polarity terminals of the battery as well as to the circuit to power the circuit.

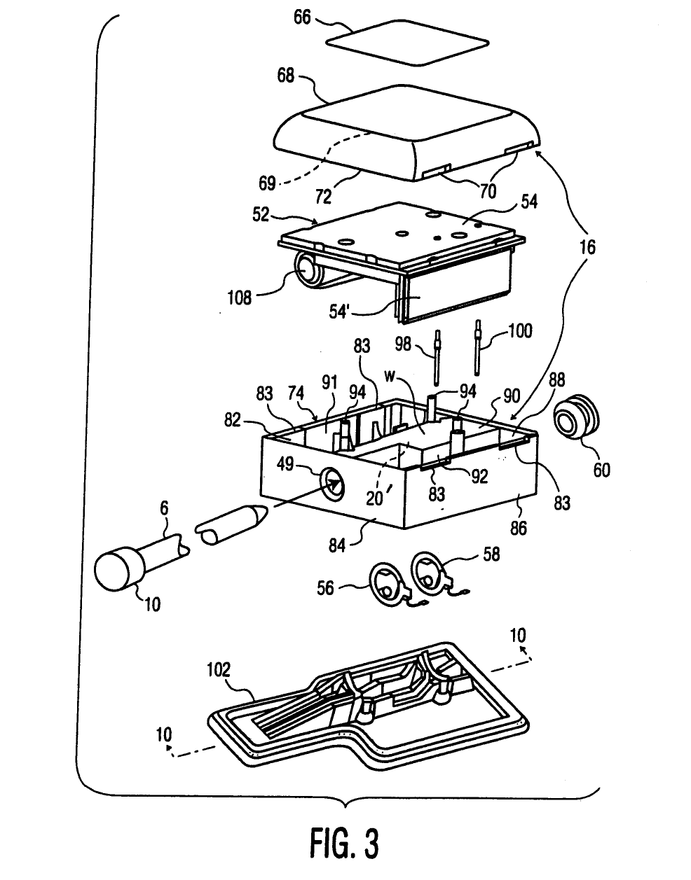

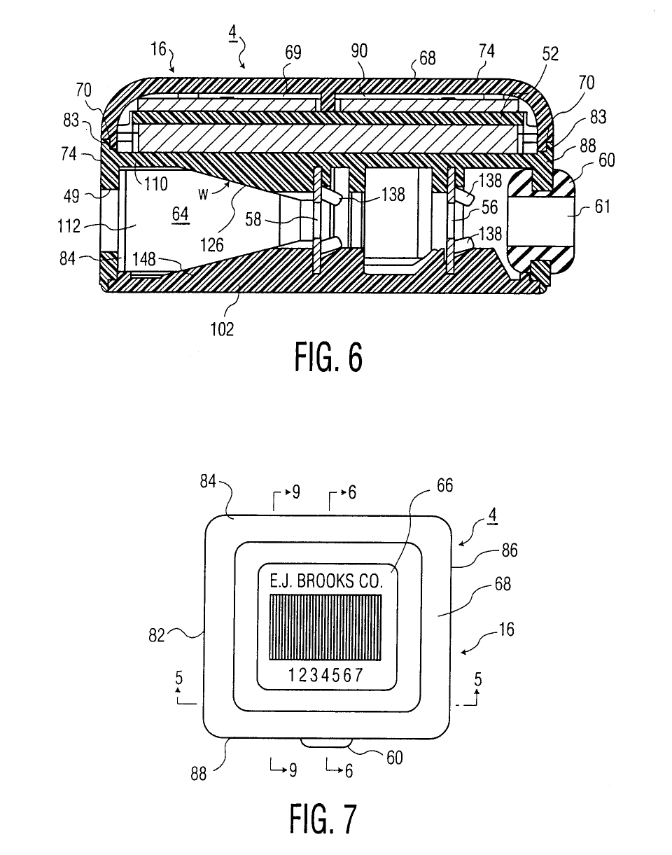

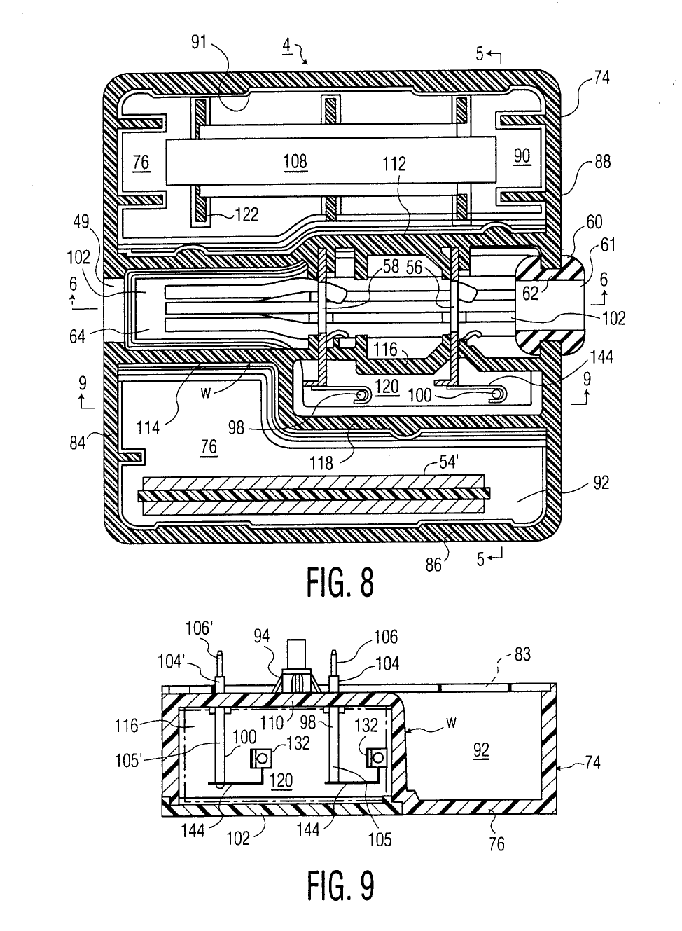

The module 4 is shown in exploded view from the bottom toward the top in FIG. 2 and from the top toward the bottom in FIG. 3. FIG. 2 shows the bolt egress wall 88 to the left (and FIGS. 6 and 8) with aperture 62 to which the grommet 60 is attached. The bolt (not shown) exits from the grommet 60 as shown in FIGS. 12 and 13. FIGS. 3, 6 and 8 show the bolt ingress wall 84 to the left with the opening 49 into which the bolt 6 is initially inserted. The module 4, FIGS. 2 and 3, comprises, from the top of the drawing down, the following. A label 66 which receives the appropriate indicia identifying the seal and related information. The label 66 is bonded to the top surface of thermoplastic molded top cover 68 of the module housing 16 and has an internal concave chamber 69. The cover 68 has snap fit elements 70 molded into and along the bottom edge of its lower rim 72, FIGS. 2 and 3.

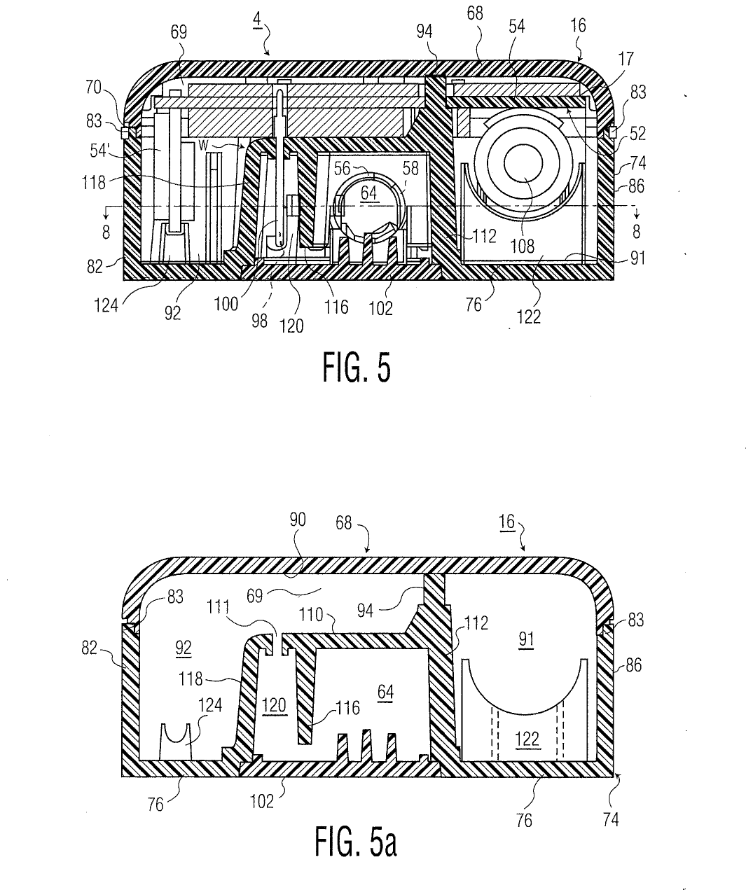

The module 4 housing 16 includes a molded thermoplastic bottom housing member 74, FIGS. 5-8, which is complementary to cover 68. The housing member 74 has outer planar orthogonal side walls 82, 84, 86 and 88. Recesses 83 on the top edge of walls 82, 84, 86 and 88 mate with corresponding recesses on the edge of the rim 72 of the cover 68. Snap fit elements 70 (FIG. 3) on the upper edges of the bottom member 74 mate with complementary elements 70 on the cover 68 bottom edge to attach the cover to the member 74. The member 74 has a bottom wall 76 with an L-shaped opening 20, FIG. 2, providing access to compartment 64 through which the bolt 6 is passed through.

The cover 68 and the walls 76, 82, 84, 86 and 88 of the housing 16 form an interior cavity 90 which is divided into central bolt receiving compartment 64 and outer compartments 91, 92 on either side of compartment 64 and chamber 69. Upper chamber 69, FIG. 5, communicates between compartments 91 and 92 adjacent to the cover 68. Chamber 69 is formed by the cover 68 and the top wall 110 of central compartment 64. Compartment 64 is formed by walls w, FIG. 3. Compartment 64 divides the cavity 90 into the compartments 91 and 92 and chamber 69. The walls w of compartment 64 form an L-shaped box-like structure which define the shape of compartment 64 located within cavity 90.

The walls w of the compartment 64, FIGS. 5, 5a, and 8, and as best seen in FIGS. 5a and 8, include a top wall 110 and side walls 112, 114. Wall 114 is continuous with spaced apart walls 116 and 118, FIG. 8, which form compartment 120 within compartment 64. The walls 112 and 116 form a continuous compartment 64 with walls 112 and 114. Walls 112 and 118, FIG. 5, are molded integral and one piece with the bottom wall 76. The wall 116 is of shorter height than walls 112 and 118 and depends from top wall 110. Wall 116 terminates spaced from the plane of the bottom wall 76 so that compartments 120 and 64 communicate adjacent to bottom cover 102, FIG. 5.

The walls 112, 116, FIG. 8, have slots for receiving the ring contacts 56, 58. A portion of the contacts 56, 58 extends into the compartment 120. The chamber 69 between the top wall 110, FIG. 5a, and the cover 68 is part of cavity 90 which includes the compartments 91 and 92. The compartments 91 and 92 with communicate with each other by way of chamber 69 forming a single\ cavity 90.

The battery 108, FIG. 5, is located in compartment 91 and the depending portion board 54′ of the circuit board 54 depends into compartment 92. The housing 16 has ribs 122 for supporting the battery 108, FIGS. 5, 5a. The compartment 92 has ribs 124 for supporting the board 54′. The top wall 110, FIG. 6, has inclined ribs 126 for guiding the bolt 10 during insertion into the housing aperture 49. The pins 98, 100 are permanently molded fixed to the top wall 110, FIG. 5, with their collars 104, 104′ (FIG. 9) abutting the outer surface of the top wall 110. The pins 98, 100 fit in holes 111, FIG. 5a, in the top wall 110, and may be molded to the top wall as the housing member 74 is formed or inserted into the holes 111 later as desired. The walls 110, 112 and 118 forming the compartment 64 divide the housing 16 cavity 90 into the three compartments 64, 91, 92, FIG. 5a, and chamber 69, FIG. 5a. The top wall 110 lies in approximately the plane of the recesses 83 of the housing member 74 side walls upper edges, FIG. 5a. In FIG. 9, the pins 98, 100 have respective shanks 105, 105′ on one side of the collars 104, 104′ and respective smaller diameter tip portions 106, 106′ on the side of the collars opposite the shanks.

In FIGS. 11a, 11b and 11c, representative contact 56 is shown. Contact 56 comprises a planar sheet metal ring 128, which may be the metal discussed above, having an elongated rectangular leg 130 extending from the edge of the ring. The leg 130 has a lip 132 that is bent at right angles thereto. The lip 132 has a hole 134. The ring 128 defines an inner circular cylindrical opening 136. Three like dimensioned contacts 138 are bent from the sheet metal forming the ring 128. The contacts are bent at an angle to the plane of the ring 128 such that the contacts 138 are resilient and can flex in directions relative to the plane of the ring 128. The contacts terminate in lips 140 which are bent at an angle to the plane of the contacts 138. A metal wire 144 has a portion passed through the hole 134 of the lip 132 of each of the contacts 56, 58 and soldered to the lip. The wire 144 has a loop 146 at its extended end. The loop 146 is attached to a corresponding one of the pins 98, 100, FIG. 8, by soldering or other method to form an electrically conductive connection to the pins.

In FIG. 11c, the lips 140 define a circular aperture that is smaller than the diameter of the bolt shank passing therethrough, FIGS. 12 and 13. The bare shank portion 14, FIG. 12, resiliently slidably and ohmically engages the lips of contact 58. The lips of contact 56 engage the electrically conductive layer 42 in sliding resilient ohmic engagement. The sliding engagement minimizes damage to the layer 42 and to the surface of the shank portion 14.

Top wall 110, FIG. 9, has three upstanding molded plastic stanchions 94, one being shown in this figure. Printed circuit board assembly 52 is attached to the stanchions 94, FIG. 5. The assembly 52 comprises a main circuit board 54 and an auxiliary printed circuit board 54′ attached normal to the main board 54. The printed circuit board 54 is supported by the three stanchions 94 in space 95 of the housing 16. The auxiliary circuit board 54′ depends from board 54 into compartment 92, FIG. 5. The pins 98 and 100 attached to wall 110 are soldered (not shown) to the mating contact pads (not shown) on the board 54 of the assembly 52. The battery 108 is also attached to board 54 and electrically coupled to its circuit to power the circuit. As noted, the battery does not power up the circuit until the bolt is inserted and engaged therewith via contacts 56, 58.

A representative pin 98 is shown in FIG. 4. Pin 98 is cylindrical metal having an annular collar 104, an elongated shank 105 terminating at the collar 104 and a narrower extension 106 extending from the collar 104 opposite the shank 105. The loop 146, FIG. 11c, is soldered to the end portion of the shank 105, FIG. 9.

A bottom cover 102 encloses the compartment 64 and is attached to the bottom wall 76 by snap fit devices molded into in the cover 102 and bottom wall 76. The bottom cover 102 is complementary to the opening 20′ to the compartment 64. The bottom cover as is all of the housing 16 and top cover 68 comprise molded thermoplastic material.

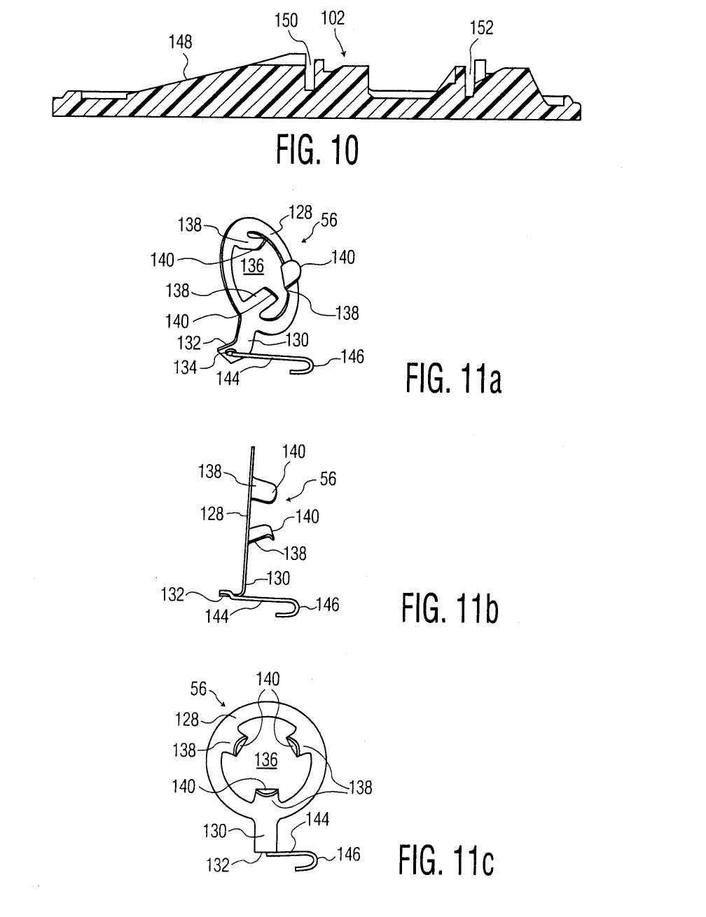

The bottom cover, FIG. 10 has inclined ribs 148 which cooperate with ribs 126 in the top wall 110, FIG. 6, to form a tapering egress opening for receiving, guiding and aligning the bolt 10 during insertion with the grommet 60 and the contacts 56, 58. This guiding action aligns the bolt 10 tip portion 14, FIG. 13, with the opening 136 in the ring contacts, FIG. 11a and the opening in the grommet 60. Slots 150 and 152, FIG. 10, are formed in the cover 102 to receive the mating ring contacts 56, 58, FIG. 6.

When the shank 14 is received in the module 4, the shank of the bolt 6 makes electrical ohmic connection with the contacts 56, 58. This arms the circuit. Subsequent interruption of a signal in the circuit by breaking the conductor path formed by the bolt 6 is sensed by the circuit in a sensor portion. This changes the codes in the circuit and causes the generation of a “tamper” signal, i.e., a second code. The tamper signal may be the word “tamper” which is generated and transmitted instead of the normal signal or first code. Power is supplied to the circuit after the bolt is inserted by closure of the engaged contacts 56, 58 by the bolt 6.

The circuit may include a programmable RFID tag circuit including a controller comprising a CPU and memory, e.g., an EPROM, an electronically programmable ROM, which may be programmed by programming arrangement (not shown) and other memory such as a ROM and so on. The circuit may include the circuit elements of the circuit of FIG. 33 and further including the programmable EPROM. The circuit includes a transmitter and a transmission antenna. Transmitter, once energized by the insertion of the bolt, may according to its program, transmit the encoded signal intermittently at random time intervals, for example, in the range of 1-10 seconds, and which may be conventional, or other periods. The circuit includes a programmable arrangement for programming a given ID, a first code or normal signal.

Once the circuit is energized, the circuit may be programmed to begin transmission of the data, previously programmed into the circuit, via transmitter or in the alternative, selectively in response to interrogation in a different embodiment. This data includes a first code manifesting the serial number of the seal module 4 and other data noted above. This data preferably is transmitted periodically every few seconds at random intervals, for example, or upon interrogation, in the alternative. The battery 108 may be permanent and has a life sufficient for this purpose for the anticipated life of the seal module 4.

In FIG. 34, in electronic system 248, a locking bolt 251 is inserted into the seal housing 16 (FIG. 1). This activates the controller 253 which causes the first code signal generator 256 to generate a first code manifesting a locked seal module 4. The transmitter 258 through the controller 253 transmits the first code to a reader 250, which may be conventional. The reader includes an antenna, a receiver and a circuit for decoding the received signal and converting it to the desired data for further transmission or display.

If the circuit is interrupted by severing the bolt or the coating 44, FIG. 12, the circuit immediately senses this condition. Electrical power is applied to the circuit at all times while the bolt is inserted. The circuit 252 will transmit automatically or, in the alternative in a different embodiment, upon interrogation, via transmitter 258, a new code manifesting a tampering condition to the reader 250.

The interruption of the circuit 252 by a tampered bolt 259 is sensed by the controller 253 which immediately causes the generation of the second code by generator 260 and disables the first code generation. Reader 250 reads the seal data transmitted by transmitter 258 under control of the controller 253.

The program of circuit 252, in response to momentary interruption of power, or interruption of the circuit by severing the bolt, is programmed to transmit the message “tamper.” The reader 250, which may be hand held or permanently installed, adjacent to a conveyer of the cargo container or roadway for a trailer truck, receives the transmitted signal. The reader is coupled to a local, but remote computer (not shown). The tamper signal from the reader is forwarded to the computer which also indicates this state with a display and may be programmed to set off an audible and/or visual alarm also or in the alternative. This alarm is immediate and the transmitted signal immediately identifies the seal and the container that has been tampered with. The tampering is noted at a given container location by reading the transmitted signal at different shipping and receiving points.

In FIG. 15, a bolt 6′ substantially the same as bolt 6 is shown. The difference is that the head 10′ comprises a separate piece 152 that is press fitted onto the shank 12′. The tip portion 14 also shows the annular groove 154 used to mate with the locking device 8 ring 26. The metal coating 42′ is applied to the shank 12′ at the head region as a continuous layer 156 in the head region. When the piece 152 is assembled, it is assembled over and in contact with the layer 156.

In operation, in FIG. 1, when the locked bolt 6 is to be removed, its shank is severed at collar 34. This permits the remaining piece of the bolt 6 shank 12 to be retracted from within and through the module 4 interior compartment 64 and removed from the hasp 9,9′. The relatively low cost retracted bolt 6 shank 12 and the severed tip portion 14 with the locking device 8 are discarded and the relatively more costly module 4 with its internal electronics can then be reused with another new bolt and locking device.

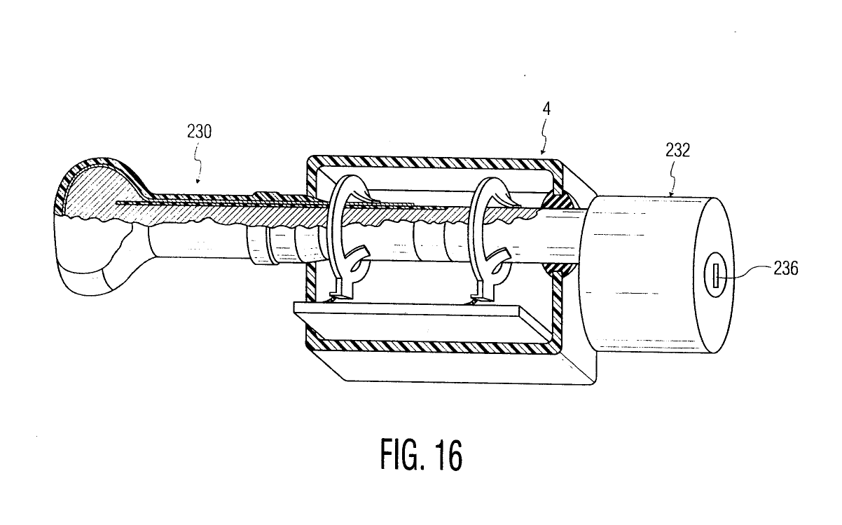

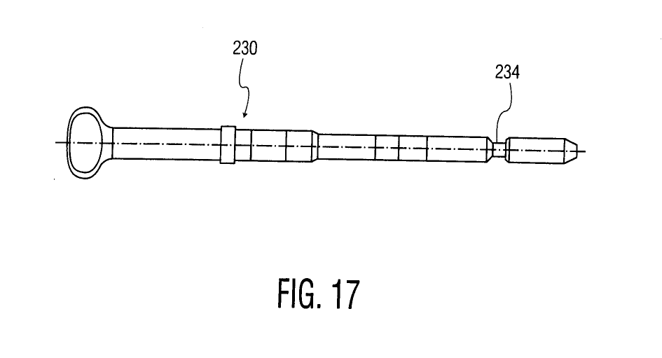

In FIG. 16, in a further embodiment, a bolt 230 is locked to module 4 by a key operated padlock 232. In FIGS. 16 and 17, the bolt 230 has a construction similar to that of the bolt 6′ of FIG. 15. The difference is that groove 154 of the bolt 6′ is widened into groove 234, FIG. 17. This widened groove is arranged to receive a key operated reciprocating locking element (not shown) of a padlock 232. Such a key operated padlock is shown for example in U.S. Pat. No. 6,778,083, incorporated by reference herein. In lock 232, the locking element (not shown) is reciprocated into and out of the groove 234 by operation of a conventional key (not shown) inserted into the key hole 236. In this case, the removal of the lock 232 permits the bolt to be removed from the module 4 which can then be reused intact with that bolt and padlock or another padlock with a different key, if desired.

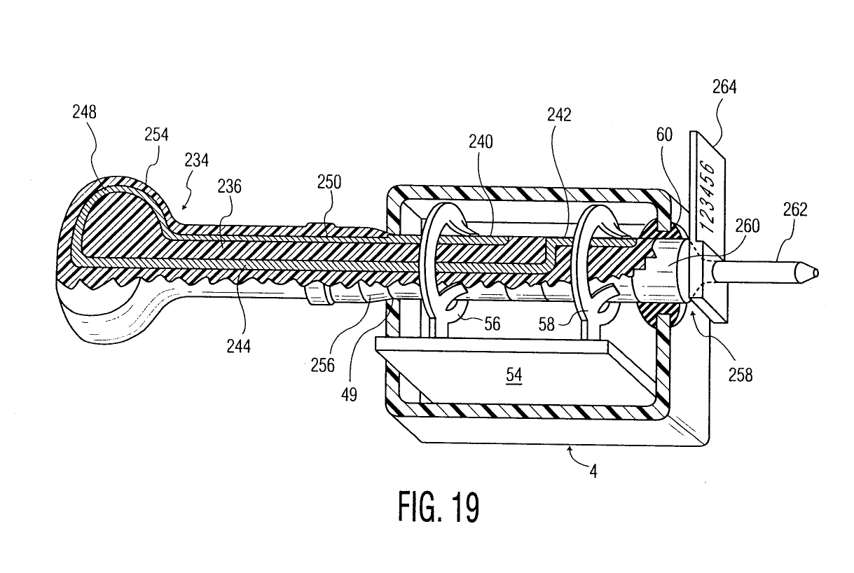

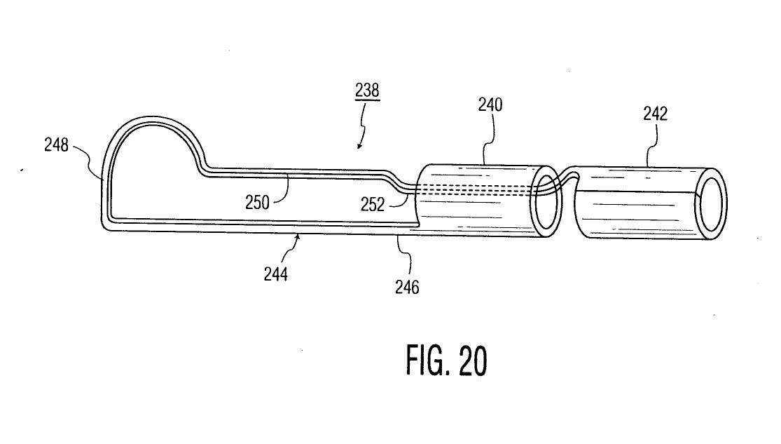

In FIGS. 19 and 20, a bolt 234 is shown which has a somewhat different configuration than the prior discussed bolts. The shank 236 is molded thermoplastic material which is electrically non-conductive, i.e., an electrical insulator. The bolt 234 has an electrically conductive metal, for example, conductor 238, FIG. 20, molded with the shank 236 to form the bolt structure. The conductor 238 comprises two aligned metal cylinders 240, 242 of like diameter and thickness. The cylinders 240, 242 may be sheet metal, for example, stainless steel or beryllium or the like. The cylinders 240 and 242 are interconnected by a metal strip 244 and are of like diameter, length and sheet metal material in this embodiment.

The strip 244, which is a relatively narrow band of sheet metal, has an elongated section 246. Section 246 is linear, one piece with and formed from and extends at one end thereof from cylinder 240. The other end of the section 246 is bent in the shape of an inverted U at section 248. A second linear section 250 extends from the section 248 and terminates at its end at cylinder 242. Section 250 has a segment 252 that is juxtaposed with the cylinder 240 and extends interior the cylinder 240. The juxtaposed segment 252 is electrically isolated from the cylinder 240.

In one embodiment, the electrical isolation is provided by spacing the segment 252 from the cylinder 240 interior surface so that when the plastic shank 236 is formed embedding the strip 244 as shown in FIG. 19, the plastic material physically secures and electrically isolates the segment 252 from the cylinder 240. The plastic shank 236 material electrically isolates the sections 244 and 250 in spaced relationship. This forms the sections 246, 248, 250 and segment 252 into one continuous conductor embedded within the shank 236. The cylinders 240 and 242, however, are formed into exposed spaced apart peripheral electrical contact surfaces of the bolt 234.

The bolt 234 has a coating of rubber or other insulating material 254 similar to the bolt 6 of FIGS. 12 and 13. The coating material 254 has a tapered region 256 for forming a seal with the aperture 49 of the module 4 housing as described above to preclude contamination from entering to the housing interior at this region. The shank 236 has a tip portion 258 formed of molded thermoplastic material. The tip portion 258 has a section 260 that is about the same diameter as the cylinders 240 and 242. Section 260 then tapers into a narrow further tip 262 that is similar to a thin rod, also of thermoplastic material.

A tamper evident seal 264 is then attached to the tip 262. The tamper indicative seal 264 is molded thermoplastic material with an interior metal tang locking device (not shown). Such locking tang devices are commonly used in conventional molded thermoplastic tamper evident seals. For example, see U.S. Pat. No. 5,524,945, incorporated by reference herein, for seals with such locking metal tang devices. The tangs of the locking device of that seal define a diameter smaller than the diameter of the tip 262 in one embodiment. When the tip 262 is slid through the aperture of the seal 264, the tangs dig into the softer material plastic tip 262 forming a one way clutch locking action so that the seal 264 or bolt must be destroyed to remove the seal and open the bolt.

In another embodiment, the tangs of the seal locking device may be provided of hard metal so they can dig into the surface of even a metal shank having a narrow tip such as tip 262, FIG. 19. In a further alternative, the tip 262, FIG. 19, in a hard steel shank may be provided with a groove such as one similar to groove 18, FIG. 12, for receiving the tangs of the seal 264, the tangs being flexible for riding on and along the bolt tip 262 surface and then resiliently engage the groove interior along the tip 262 for locking the seal to the bolt.

By severing the tip 262, or destroying the seal 264, the seal 264 is readily removed and the bolt then can be removed from the module 4 and also from the locked hasps. The module 4 is thus readily reused with the same bolt when only the seal is destroyed and a new seal. The seal may have a unique serial no. assigned.

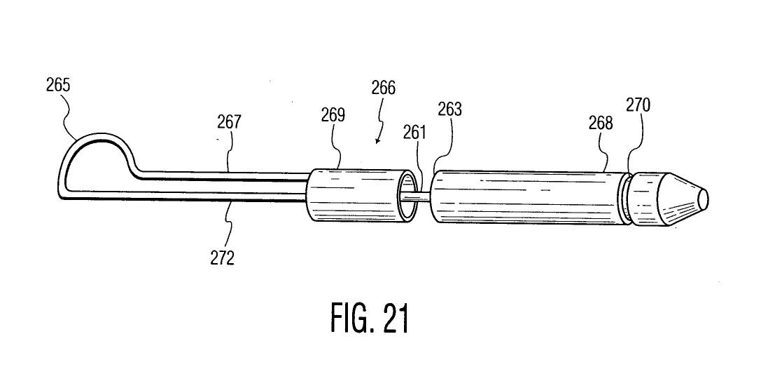

In FIG. 21, a further embodiment of the conductors associated with a bolt is shown such as used with a thermoplastic molded shank as shown in FIG. 19. In FIG. 21, only the conductive elements are shown for use with a non-electrically conductive shank of the type shown in FIG. 19 for example. Metal electrical conductor 266 comprises stamped sheet metal similar to the conductor 238 of FIG. 20. Conductor 266 comprises a solid steel cylindrical shank 268 tip portion. The shank 268 has an annular groove 270 for receiving a conventional ring type locking device of the type disclosed in FIG. 14, with or without an outer plastic shell as desired for a given implementation.

An elongated linear metal conductor strip 272 is attached at its end 261 to the end 263 of the shank 268 by any convenient arrangement. For example the conductor 263 end may be welded to the shank, or force fit into a hole in the shank by press fit in complementary shaped portions and so on. The strip 272 is bent into an inverted U section 265. An elongated linear section 267 of the conductor strip 272 extends from the section 265 and terminates in sheet metal cylinder 269. The section 267 may be formed one piece with the cylinder 269 as by stamping and the like. Once so formed, a thermoplastic shank is molded about the conductor 266 similar to the shank 136, FIG. 19, of bolt 234. The cylinder 269 and shank 268 are then used similarly as the cylinders of the bolt 234 of FIG. 19.

In operation, the insertion of the bolt of any of the embodiments disclosed, closes a switch formed by the contacts 56, 58, powering the circuit 248, FIG. 23, via the battery 108, FIGS. 2 and 3, and activating the circuit 248. A signal is applied to and passes through the bolt conductor of any of the disclosed embodiments to and from the circuit 248. This circuit is programmed to sense the presence of this signal to show the tamper state of the seal which when powered on initially will not indicate a tamper condition but a “good” condition which may be manifested by a green light (not shown) for example. The circuit, once powered on, is armed and will transmit the programmed seal identification and related data to a local interrogator/receiver (not shown) upon interrogation.

Assume the bolt shank is severed in order to open the seal 2, FIG. 1, or the tamper indicating seal of some of the embodiments or the module 4 is removed as in others of the embodiments such that the bolt can be removed from the seal module 4. The severed bolt conductor or the disconnection of the contacts 56, 58 with the bolt of the various embodiments indicates an unlocked condition. The severing of the conductor or unlocked condition interrupts the signal supplied to and from the circuit 248, FIG. 23. The circuit program senses this interruption and is programmed to change the programming to note the tampered condition which may also be indicated by a red light (not shown) on the module. This condition is transmitted by transmitting the word “tamper” and/or a change in serial number and/or an alarm condition. When the alarm condition is read by reader 250, the integrity of that container has been breached. The reader 250 also stores the seal number of each seal that has been breached. This information is manually read from the reader 250.

If an attempt is made to pull the bolt out of the seal 2 and reprogram the circuit and then reinsert the bolt, the circuit 248 senses this and transmits “tamper.” Any attempt to cut or sever the bolt and its conductor or otherwise open the bolt and remove it from the seal module 4 causes a “tamper” signal to be generated. The tamper signal is repetitively transmitted. Thus it is important that no interruption of the circuit occurs once the circuit is powered on and armed.

Thus it is important that the contacts 56, 58 be arranged to provide positive ohmic connection to preclude any accidental interruption of power or signal to the circuit 121. It is important that the contacts not disengage due to shock loads such as dropping and rough handling of the attached container. Contacts 56, 58 withstand such shock loading.

It will occur to one of ordinary skill that various modifications may be made to the disclosed embodiments given by way of example and not limitation. It is intended that the scope of the invention be defined by the appended claims. For example, the locking mechanisms, the power source, the bolt configuration, the information stored and transmitted, the use of a movable door and a transparent housing may be changed according to a given implementation.

The contact arrangements may differ from the disclosed embodiments. Also, the bolts that are shown made of metal may be non-electrically conductive plastic or similar material (e.g., FIG. 19) and include conductors such as shown FIGS. 20 and 21, or the bolts may be made of electrically conductive plastic, hard rubber or other similar electrically conductive non-steel, non-metal shank material and employed similarly as the bolts of FIGS. 12-17. Depending upon the environment in which the seal is used locking devices and/or bolts of any degree of high, robust security or lower level, low security, or any degree therebetween, may be employed as shown

The tamper signal may comprise any suitable signal recognized as a tampered condition and transmission of the word “tamper” is given by way of illustration. In the claims, the term “locking device” is intended to include any kind of tamper evident device or security seal such as padlock or strap seals using metal or plastic tang devices or temporary seal devices that are disposable, or locking devices that permanently secure hasps and must be destroyed to open.

1. An electronic security bolt seal with a reusable electronics module for locking a hasp comprising:
an electronics circuit having first and second portions;
an electronics module comprising a unitary housing having a primary cavity, the first portion of the electronics circuit being entirely in the primary cavity for sensing and transmitting a tamper state of the seal;
a bolt having a head and an elongated shank engaged with the housing cavity, the bolt including the second portion of the electronics circuit engaged with the first portion of the electronics circuit for carrying a current and completing the electronics circuit and for engaging the hasp to be locked; and
a bolt locking device engaged with and locked to the bolt external the module to secure the module to the bolt in the locked state, the electronics circuit for sensing the integrity of the engaged locked bolt manifesting the seal tamper state, the locked bolt having an exposed region external the module for selective severing of the bolt at the exposed region to interrupt the electronics circuit second portion while unlocking the seal from the hasp and release the module from the bolt for subsequent reuse of the module.

2. The bolt seal of claim 1 wherein the bolt is dimensioned to pass through the housing and includes a tip portion protruding from the housing, the tip portion and the locking device being arranged to lock the locking device to the tip portion.

3. The bolt seal of claim 1 wherein the bolt has a tip distal the head and protrudes from the module, the tip having an aperture for receiving a security seal shackle therethrough.

4. The bolt seal of claim 1 wherein the bolt has a tip distal the head and protrudes from the module, the tip having a groove therein for engaging with and locking to the locking device.

5. The bolt seal of claim 1 wherein the bolt has a tip distal the head, the bolt having one of a hole and groove therein in a region intermediate the tip and engaged module.

6. The bolt seal of claim 1 wherein the bolt comprises an electrical insulator, the bolt including first and second electrically conductive members attached to the shank in spaced electrical isolation from each other spaced from the head for ohmically engaging the circuit, and an electrical conductor ohmically connected to the conductive members and extending along the shank from the head to the members to form a circuit path to and between the conductive members.

7. The bolt seal of claim 1 including a contamination sealing arrangement for sealing the module cavity from ambient region contamination external the cavity in cooperation with the bolt.

8. The bolt seal of claim 1 wherein the bolt is dimensioned to pass through the housing and includes a tip portion protruding from the housing, the tip portion and the locking device being arranged to lock the locking device to the tip portion, further including a contamination sealing arrangement for sealing the module cavity from contamination from the external ambient region in cooperation with the bolt.

9. The bolt seal of claim 1 wherein the bolt is dimensioned to pass through the housing in a compartment in the cavity from an ingress first aperture and egress the housing at a second aperture, the bolt including a tip portion protruding from the housing through the second aperture, the tip portion and the locking device being arranged to lock the locking device to the tip portion, further including a contamination sealing arrangement comprising a grommet on the housing at the second aperture and a sealing element attached to the bolt for sealing the first aperture when the bolt is in a position for being locked, the grommet and sealing element for sealing the module compartment from ambient external contamination.

10. The bolt seal of claim 1 wherein the bolt is dimensioned to pass through a housing compartment in the cavity from an ingress first aperture and egress the housing at a second aperture, the bolt including a tip portion protruding from the housing through the second aperture, the tip portion and the locking device being arranged to lock the locking device to the tip portion, further including a contamination sealing arrangement comprising a first sealing element attached to the housing at the second aperture for sealing the mating bolt shank surface at the bolt tip region and a second sealing element coupled to the bolt for sealing the mating first aperture surface when the bolt is in a locked position, the first and second sealing elements for sealing the module compartment from external ambient region contamination in response to the locking device locking the bolt with the sealing elements in sealing engagement with their mating surfaces.

11. The bolt seal of claim 1 wherein the bolt has a tip region, and includes a first sealing element intermediate the bolt head and the tip region, the housing has a second sealing element for engaging the bolt at the tip region.

12. The bolt seal of claim 1 wherein the bolt has a tip region, and includes a first tapered sealing element surrounding the bolt at a location intermediate the bolt head and the tip region, the housing having a second sealing element for engaging the bolt at the tip region, the module being secured in a region that is generally between the first and second sealing elements.

13. The bolt seal of claim 1 wherein the locking device comprises one of a permanent and temporary locking engagement with the bolt.

14. The bolt seal of claim 1 wherein the locking device comprises a tamper evident seal with metal or plastic tangs for engaging and locking to the bolt shank.

15. The bolt seal of claim 1 wherein the locking device comprises a tamper evident seal with a shackle or tangs for engaging and locking to the bolt shank via an aperture and/or groove in the bolt.

16. A bolt for use with an electronic security seal having an electronic tamper evident sensing and transmission circuit forming an electronic tamper evidence sensing and transmitting module, the bolt comprising:
a head and a shank extending from the head to a tip portion spaced from the head;
electrical conductors coupled to the head for completing an electrical path to the electronic tamper evident sensing and transmission circuit of the security seal module; and
a tamper indicative seal attached to the tip portion.

17. The bolt of claim 16 wherein the shank is one of an electrical conductor forming one of said electrical conductors or an electrical insulator.

18. The bolt of claim 16 wherein the shank is an electrical insulator and the tip portion has a diametrical dimension smaller than the shank for receiving a one way clutch acting locking tamper indicative seal which is locked to the tip portion by the one way clutch action.

19. The bolt of claim 16 wherein the tip portion has an hole therethrough and the tamper indicative seal has a shackle portion passing through the hole.

20. The bolt of claim 16 including a tapered sealing region for sealing an electronic seal module housing aperture receiving the bolt.

21. A bolt for use with an electronic security seal module having a housing and an aperture in the housing for receiving the bolt inserted therethrough into an internal housing compartment, the received bolt for engagement with tamper evident sensing circuitry in the compartment, the bolt comprising:
a head and a shank extending from the head to a tip portion distal the head, the shank being dimensioned to be inserted through the aperture into the compartment;
electrical conductors coupled to the head and shank for completing an electrical path to the circuitry along the shank and in the head; and
a sealing arrangement attached to and encircling the shank for engagement with the module housing at the aperture for sealing the interface of the sealing arrangement with the module housing at the aperture wherein the shank has an outer peripheral surface, the sealing arrangement comprising a sealant material on the outer peripheral surface of the bolt tapering to a relatively narrow diameter in a direction from the bolt head to the tip portion wherein the tapered region is engaged with said aperture.

22-23. (canceled)

24. The bolt of claim 21 wherein the sealing arrangement comprises an electrically insulating coating.

25. The bolt of claim 21 wherein the sealing arrangement comprises an electrically insulating coating extending about the shank and head from a region medially the bolt shank to and over the head.

26. The bolt of claim 21 wherein the sealing arrangement comprises a continuous electrically insulating coating extending about the shank and head from a region medially the bolt shank to and over the head.

27. A bolt for use with an electronic security seal module having a housing having a cavity containing a tamper sensing circuit and an aperture in the housing for receiving the bolt therethrough into the housing cavity, the bolt for engaging the tamper sensing circuit, the bolt comprising:
a head, and a shank extending from the head to a tip portion distal the head and dimensioned to be inserted into the aperture;
electrical conductors coupled to the head and shank for completing an electrical path to the engaged circuit along the shank and in the head; and
a tapered sealing arrangement attached to and encircling the shank medially the shank for engaging the module housing at the aperture to thereby seal the bolt to the module housing at the aperture.
